(19) United States
(12) Patent Application Publication
(10) Pub. No.: US 2025/0379815 A1
(43) Pub. Date: Dec. 11, 2025

(54) SERVICE IDENTIFICATION IN IPV6 ENCAPSULATIONS

(71) Applicant: Cisco Technology, Inc., San Jose, CA (US)

(72) Inventors: Darren Russell Dukes, Ottawa (CA); Jaganbabu Rajamanickam, Kanata (CA); Madhan Sankaranarayanan, Nadu (IN); Nagendra Kumar Nainar, Morrisville, NC (US); David Toscano, Nepean (CA)

(21) Appl. No.: 18/734,214

(22) Filed: Jun. 5, 2024

(51) Int. Cl. H04L 45/00; H04L 41/0686; H04L 43/0823; H04L 69/325

(52) U.S. Cl. CPC H04L 45/34; H04L 41/0686; H04L 43/0823; H04L 69/325

(57) ABSTRACT

In one aspect, a method includes setting, at a source node of an SRv6 network, one or more bits of a packet to indicate an ingress service identifier associated with an ingress service, where the ingress service is behind a source node; transmitting, by the source node, the packet towards a destination device of the SRv6 network; accessing, at the source node and from a network device in communication with the source node, an Internet Control Message Protocol error message that includes a portion of the packet indicating the ingress service identifier; and identifying, based on the ingress service identifier indicated by the Internet Control Message Protocol error message for the packet, the ingress service associated with the packet.

### TECHNICAL FIELD

The present disclosure relates to Path Maximum Transmission Unit (MTU) discovery and ICMP (Internet Control Message Protocol) error processing in SRv6 networks, and in particular, to improving error message handling and MTU discovery when a source node forwards a packet from an ingress service by carrying information about the ingress service within the packet in such a way that this information is retained within ICMP error messages.

### BACKGROUND

Internet Control Message Protocol (ICMP) error messages are sent on behalf of an intermediate or destination node back to a source node if there is a problem with the packet sent from the source node. These messages will include information about the type of error encountered, and will also include portions of the “offending” packet including IPv6 encapsulated headers belonging to the packet. However, current methods do not require or facilitate encoding information about an ingress service within packets, where the ingress service is behind a source node. For SRv6 micro-segments (uSIDs), identifying the ingress service from contents of an ICMP error type “packet too big” can be impossible since only the egress PE service is identified in the IPv6 destination address (which is retained within ICMP errors).

It is with these observations in mind, among others, that various aspects of the present disclosure were conceived and developed.

### BRIEF DESCRIPTION OF THE DRAWINGS

Details of one or more aspects of the subject matter described in this disclosure are set forth in the accompanying drawings and the description below. However, the accompanying drawings illustrate only some typical aspects of this disclosure and are therefore not to be considered limiting of its scope. Other features, aspects, and advantages will become apparent from the description, the drawings and the claims.

FIG. 1 illustrates an example of a high-level network architecture in accordance with an embodiment;

FIG. 2 illustrates an example of a network topology in accordance with an embodiment.

FIG. 3 illustrates an example of a diagram showing the operation of a protocol for managing an overlay network in accordance with an embodiment.

FIG. 4 illustrates an example of a diagram showing the operation of virtual private networks for segmenting a network in accordance with an embodiment;

FIG. 5 illustrates an example network topology outlining a problem with current methods of ICMP error handling and path MTU discovery in SRv6 networks;

FIG. 6A is a first simplified diagram showing an example network topology outlining improvement of ICMP error handling and path MTU discovery in SRv6 networks by inclusion of an ingress service identifier within a packet in accordance with an embodiment;

FIG. 6B is a second simplified diagram continuing the example in FIG. 6A, and showing an example network topology outlining improvement of ICMP error handling and path MTU discovery in SRv6 networks by inclusion of the ingress service identifier within the packet in accordance with an embodiment;

FIG. 7A illustrates SRv6 encapsulation that incorporates an ingress service identifier in accordance with an embodiment;

FIG. 7B illustrates an example ICMP error message that incorporates an ingress service identifier in accordance with an embodiment;

FIG. 8A is a first process flow diagram showing a process for improving ICMP error message handling and path MTU discovery in SRv6 networks in accordance with an embodiment;

FIG. 8B is a second process flow diagram continuing the process of FIG. 8A for improving ICMP error message handling and path MTU discovery in IPv6 networks in accordance with an embodiment;

FIG. 9 illustrates an example network device in accordance with an embodiment; and

FIG. 10 shows an example of a computing system which can be for example any computing device that can implement aspects of the methods outlined herein in accordance with an embodiment.

### DETAILED DESCRIPTION

The detailed description set forth below is intended as a description of various configurations of embodiments and is not intended to represent the only configurations in which the subject matter of this disclosure can be practiced. The appended drawings are incorporated herein and constitute a part of the detailed description. The detailed description includes specific details for the purpose of providing a more thorough understanding of the subject matter of this disclosure. However, it will be clear and apparent that the subject matter of this disclosure is not limited to the specific details set forth herein and may be practiced without these details. In some instances, structures and components are shown in block diagram form in order to avoid obscuring the concepts of the subject matter of this disclosure.

### Overview

Systems, methods, and computer-readable media are provided for improving Path Maximum Transmission Unit (PMTU) discovery and Internet Control Message Protocol (ICMP) error processing in SRv6 networks. Current methods do not require encoding information about the ingress service within packets. For SRv6 micro-segments (uSIDs), identifying the ingress service from contents of an ICMP error type “packet too big” can be impossible since only the egress PE service is identified in the IPV6 destination address (which is retained within ICMP error messages). In particular, the systems and methods outlined herein aim to improve error message handling and Maximum Transmission Unit (MTU) discovery when a source node forwards a packet from an ingress service (e.g., a VPN behind a “head-end” source node) by carrying information about the ingress service within the packet in such a way that this information is retained within ICMP error messages, particularly those pertaining to ICMP “packet too big” (PTB) error messages.

In one aspect, a method includes setting, at a source node of an SRv6 network, one or more bits of a packet to indicate an ingress service identifier associated with an ingress service, where the ingress service is behind a source node; transmitting, by the source node, the packet towards a destination device of the SRv6 network; accessing, at the source node and from a network device in communication with the source node, an Internet Control Message Protocol error message that includes a portion of the packet indicating the ingress service identifier; and identifying, based on the ingress service identifier indicated by the Internet Control Message Protocol error message for the packet, the ingress service associated with the packet.

In another aspect, the method further includes setting, at the source node and based on the Internet Control Message Protocol error message, a Maximum Transmission Unit for the ingress service towards the destination device, identifiable by a tuple that includes a service identifier associated with the ingress service, a service type associated with the ingress service, and a destination address associated with the destination device.

In another aspect, the method further includes transmitting, by the source node and based on the Internet Control Message Protocol error message, a message towards the ingress service that indicates that the packet is too large.

In another aspect, the method further includes searching, by the source node, for the ingress service identifier based on the portion of the packet indicating the ingress service identifier present within the Internet Control Message Protocol error message.

In another aspect, the one or more bits of the packet indicating the ingress service identifier being part of a flow label of the packet.

In another aspect, the method further includes setting, at the source node, one or more remaining bits of the flow label of the packet to include a flow identifier associated with a flow for the packet.

In another aspect, the one or more bits of the packet indicating the ingress service identifier being part of a Segment Routing Header (SRH) Type Length Value (TLV) of the packet.

In another aspect, the ingress service identifier being associated with a plurality of ingress services and/or a plurality of policies that share a common path.

In another aspect, the plurality of policies each including a segment identifier list having a last segment identifier, the last segment identifier being an adjacency segment identifier.

In another aspect, the method further includes packet being a Path Maximum Transmission Unit Discovery probe packet.

In another aspect, the method further includes generating the Path Maximum Transmission Unit Discovery probe packet that includes the ingress service identifier for a plurality of ingress services and/or a plurality of policies that share a common path.

In one aspect, a system includes one or more processors in communication with at least one computer-readable storage medium storing instructions which, when executed by the one or more processors, cause the one or more processors to set, at a source node of an SRv6 network, one or more bits of a packet to indicate an ingress service identifier associated with an ingress service, where the ingress service is behind a source node; transmit, by the source node, the packet towards a destination device of the SRv6 network; access, at the source node and from a network device in communication with the source node, an Internet Control Message Protocol error message that includes a portion of the packet indicating the ingress service identifier; and identify, based on the ingress service identifier indicated by the Internet Control Message Protocol error message for the packet, the ingress service associated with the packet.

In one aspect, one or more non-transitory computer-readable storage media include computer-readable instructions stored thereon which, when executed by one or more processors, cause the one or more processors to set, at a source node of an SRv6 network, one or more bits of a packet to indicate an ingress service identifier associated with an ingress service, where the ingress service is behind a source node; transmit, by the source node, the packet towards a destination device of the SRv6 network; access, at the source node and from a network device in communication with the source node, an Internet Control Message Protocol error message that includes a portion of the packet indicating the ingress service identifier; and identify, based on the ingress service identifier indicated by the Internet Control Message Protocol error message for the packet, the ingress service associated with the packet.

### EXAMPLE EMBODIMENTS

### SDWAN Network Architecture

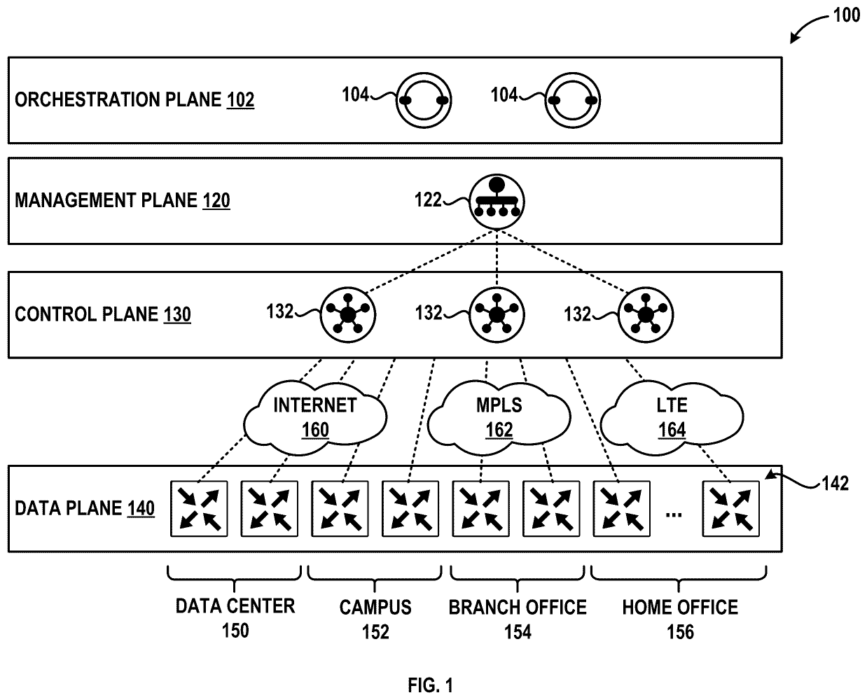

FIG. 1 illustrates an example of a network architecture 100 for implementing aspects of the present technology. An example of an implementation of the network architecture 100 is the Cisco® SD-WAN architecture. However, one of ordinary skill in the art will understand that, for the network architecture 100 and any other system discussed in the present disclosure, there can be additional or fewer component in similar or alternative configurations. The illustrations and examples provided in the present disclosure are for conciseness and clarity. Other embodiments may include different numbers and/or types of elements but one of ordinary skill the art will appreciate that such variations do not depart from the scope of the present disclosure.

In this example, the network architecture 100 can comprise an orchestration plane 102, a management plane 120, a control plane 130, and a data plane 140. The orchestration plane 102 can assist in the automatic on-boarding of edge network devices 142 (e.g., switches, routers, etc.) in an overlay network. The orchestration plane 102 can include one or more physical or virtual network orchestrator appliance(s) such as network orchestrator appliance(s) 104. The network orchestrator appliance(s) 104 can perform the initial authentication of the edge network devices 142 and orchestrate connectivity between devices of the control plane 130 and the data plane 140. In some embodiments, the network orchestrator appliance(s) 104 can also enable communication of devices located behind Network Address Translation (NAT). In some embodiments, physical or virtual Cisco® SD-WAN vBond appliances can operate as the network orchestrator appliance(s) 104.

The management plane 120 can be responsible for central configuration and monitoring of a network. The management plane 120 can include one or more physical or virtual network management appliances such as network management appliance(s) 122. In some embodiments, the network management appliance(s) 122 can provide centralized management of the network via a graphical user interface to enable a user to monitor, configure, and maintain the edge network devices 142 and links (e.g., transport network 160, MPLS network 162, 4G/LTE network such as the mobile network 164) in an underlay and overlay network. The network management appliance(s) 122 can support multi-tenancy and enable centralized management of logically isolated networks associated with different entities (e.g., enterprises, divisions within enterprises, groups within divisions, etc.). Alternatively or in addition, the network management appliance(s) 122 can be a dedicated network management system for a single entity. In some embodiments, physical or virtual Cisco® SD-WAN vManage appliances can operate as the network management appliance(s) 122.

The control plane 130 can build and maintain a network topology and make decisions on where traffic flows. The control plane 130 can include one or more physical or virtual network controller appliances such as network controller appliance(s) 132. The network controller appliance(s) 132 can establish secure connections to each of the edge network device 142 and distribute route and policy information via a control plane protocol (e.g., Overlay Management Protocol (OMP) (discussed in further detail below), Open Shortest Path First (OSPF), Intermediate System to Intermediate System (IS-IS), Border Gateway Protocol (BGP), Protocol-Independent Multicast (PIM), Internet Group Management Protocol (IGMP), Internet Control Message Protocol (ICMP), Address Resolution Protocol (ARP), Bidirectional Forwarding Detection (BFD), Link Aggregation Control Protocol (LACP), etc.). In some embodiments, the network controller appliance(s) 132 can operate as route reflectors. The network controller appliance(s) 132 can also orchestrate secure connectivity in the data plane 140 between and among the edge network devices 142. For example, in some embodiments, the network controller appliance(s) 132 can distribute crypto key information among the edge network devices 142. This can allow the network to support a secure network protocol or application (e.g., Internet Protocol Security (IPSec), Transport Layer Security (TLS), Secure Shell (SSH), etc.) without Internet Key Exchange (IKE) and enable scalability of the network. In some embodiments, physical or virtual Cisco® SD-WAN vSmart controllers can operate as the network controller appliance(s) 132.

The data plane 140 can be responsible for forwarding packets based on decisions from the control plane 130. The data plane 140 can include the edge network devices 142, which can be physical or virtual network devices. The edge network devices 142 can operate at the edges various network environments of an organization, such as in one or more data centers or colocation center(s) 150, campus network(s) 152, branch office network(s) 154, home office network(s) 156, and so forth, or in the cloud (e.g., Infrastructure as a Service (IaaS), Platform as a Service (PaaS), SaaS, and other cloud service provider networks). The edge network devices 142 can provide secure data plane connectivity among sites over one or more WAN transports, such as via one or more of the transport network 160 (e.g., Digital Subscriber Line (DSL), cable, etc.), MPLS networks 162 (or other private packet-switched network (e.g., Metro Ethernet, Frame Relay, Asynchronous Transfer Mode (ATM), etc.), mobile networks 164 (e.g., 3G, 4G/LTE, 5G, etc.), or other WAN technology (e.g., Synchronous Optical Networking (SONET), Synchronous Digital Hierarchy (SDH), Dense Wavelength Division Multiplexing (DWDM), or other fiber-optic technology; leased lines (e.g., T1/E1, T3/E3, etc.); Public Switched Telephone Network (PSTN), Integrated Services Digital Network (ISDN), or other private circuit-switched network; small aperture terminal (VSAT) or other satellite network; etc.). The edge network devices 142 can be responsible for traffic forwarding, security, encryption, quality of service (QOS), and routing (e.g., BGP, OSPF, etc.), among other tasks. In some embodiments, physical or virtual Cisco® SD-WAN vEdge routers can operate as the edge network devices 142.

### SDWAN Network Topology

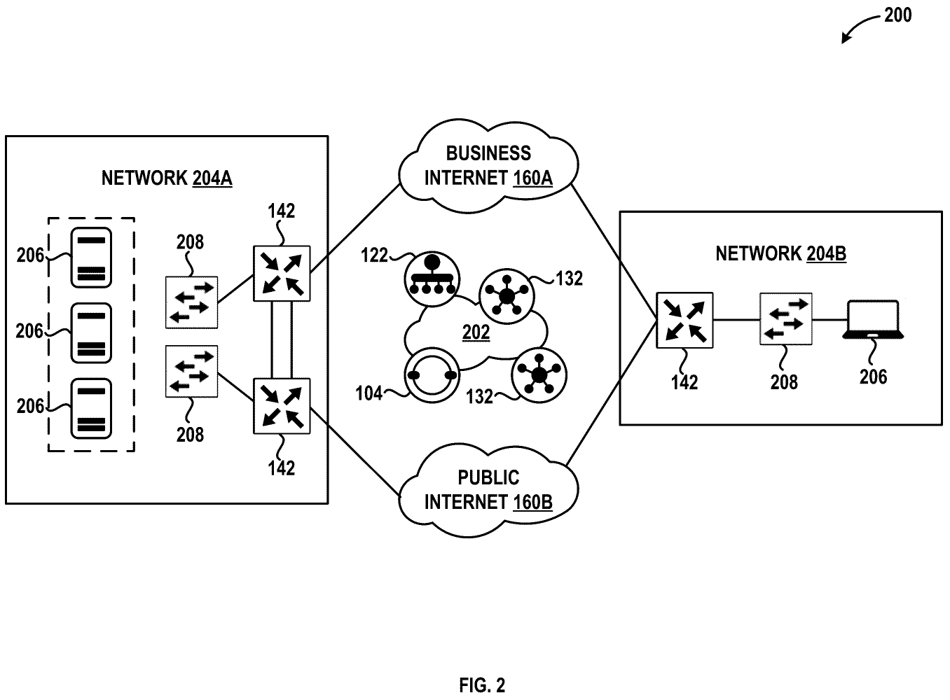

FIG. 2 illustrates an example of a network topology 200 for showing various aspects of the network architecture 100. The network topology 200 can include a management network 202, a pair of network sites including network site 204A and network site 204B (e.g., the data center(s) 150, the campus network(s) 152, the branch office network(s) 154, the home office network(s) 156, cloud service provider network(s), etc.), and a pair of Internet transport networks 160A and Internet transport network 160B (collectively, the transport network 160). The management network 202 can include one or more of the network orchestrator appliance(s) 104, one or more network management appliance(s) 122, and one or more network controller appliance(s) 132. Although the management network 202 is shown as a single network in this example, one of ordinary skill in the art will understand that each element of the management network 202 can be distributed across any number of networks and/or be co-located with the network site 204A and the network site 204B. In this example, each element of the management network 202 can be reached through either the Internet transport network 160A or the Internet transport network 160B.

Each site can include one or more endpoints 206 connected to one or more site network devices 208. The one or more endpoints 206 can include general purpose computing devices (e.g., servers, workstations, desktop computers, etc.), mobile computing devices (e.g., laptops, tablets, mobile phones, etc.), wearable devices (e.g., watches, glasses or other head-mounted displays (HMDs), car devices, etc.), and so forth. The one or more endpoints 206 can also include Internet of Things (IoT) devices or equipment, such as agricultural equipment (e.g., livestock tracking and management systems, watering devices, unmanned aerial vehicles (UAVs), etc.); connected cars and other vehicles; smart home sensors and devices (e.g., alarm systems, security cameras, lighting, appliances, media players, HVAC equipment, utility meters, windows, automatic doors, door bells, locks, etc.); office equipment (e.g., desktop phones, copiers, fax machines, etc.); healthcare devices (e.g., pacemakers, biometric sensors, medical equipment, etc.); industrial equipment (e.g., robots, factory machinery, construction equipment, industrial sensors, etc.); retail equipment (e.g., vending machines, point of sale (POS) devices, Radio Frequency Identification (RFID) tags, etc.); smart city devices (e.g., street lamps, parking meters, waste management sensors, etc.); transportation and logistical equipment (e.g., turnstiles, rental car trackers, navigational devices, inventory monitors, etc.); and so forth.

The one or more site network devices 208 can include physical or virtual switches, routers, and other network devices. Although the network site 204A is shown including a pair of site network devices and the network site 204B is shown including a single site network device in this example, the one or more site network devices 208 can comprise any number of network devices in any network topology, including multi-tier (e.g., core, distribution, and access tiers), spine-and-leaf, mesh, tree, bus, hub and spoke, and so forth. For example, in some embodiments, one or more data center networks may implement the Cisco® Application Centric Infrastructure (ACI) architecture and/or one or more campus networks may implement the Cisco® Software Defined Access (SD-Access or SDA) architecture. The one or more site network devices 208 can connect the one or more endpoints 206 to one or more of the edge network devices 142, and the edge network devices 142 can be used to directly connect to the transport network 160.

In some examples, the one or more site network devices 208 and/or the one or more endpoints 206 may be “behind” the edge network devices 142, and may represent distinct Virtual Routing and Forwarding (VRF) spaces that may be unknown to other components of the network outside of their associated one or more of the edge network devices 142.

In some embodiments, “color” can be used to identify an individual WAN transport network, and different WAN transport networks may be assigned different colors (e.g., mpls, private1, biz-internet, metro-ethernet, lte, etc.). In this example, the network topology 200 can utilize a color called “biz-internet” for the Internet transport network 160A and a color called “public-internet” for the Internet transport network 160B.

In some embodiments, each site network device of the one or more site network devices 208 can form a Datagram Transport Layer Security (DTLS) or TLS control connection to the network controller appliance(s) 132 and connect to any one or more of the network control appliance(s) 132 over each transport network 160. In some embodiments, the edge network devices 142 can also securely connect to edge network devices in other sites via IPSec tunnels. In some embodiments, the BFD protocol may be used within each of these tunnels to detect loss, latency, jitter, and path failures.

On the edge network devices 142, color can be used help to identify or distinguish an individual WAN transport tunnel (e.g., no same color may be used twice on a single edge network device). Colors by themselves can also have significance. For example, the colors metro-ethernet, mpls, and private1, private2, private3, private4, private5, and private6 may be considered private colors, which can be used for private networks or in places where there is no NAT addressing of the transport IP endpoints (e.g., because there may be no NAT between two endpoints of the same color). When the edge network devices 142 use a private color, they may attempt to build IPSec tunnels to other edge network devices using native, private, underlay IP addresses. The public colors can include 3g, biz, internet, blue, bronze, custom1, custom2, custom3, default, gold, green, lte, public-internet, red, and silver. The public colors may be used by the edge network devices 142 to build tunnels to post-NAT IP addresses (if there is NAT involved). If the edge network devices 142 use private colors and need NAT to communicate to other private colors, the carrier setting in the configuration can dictate whether the edge network devices 142 use private or public IP addresses. Using this setting, two private colors can establish a session when one or both are using NAT.

In some cases, the one or more site network devices 208 and/or the one or more endpoints 206 can represent or reside in one or more tenant or customer spaces. A tenant or customer space can include workloads, services, applications, devices, networks, networks or routing domains (e.g., virtual routing and forwarding (VRF) domains, bridge domains (BDs), subnets, virtual networks, etc.) and/or resources associated with one or more clients or subscribers. In some examples, traffic in the network architecture 100 can be routed based on specific tenant policies, agreements, configurations, etc. In some cases, addressing can vary between tenants. In some examples, tenant spaces can be divided into logical segments and/or networks and separated from logical segments and/or networks associated with other tenants.

Configurations in the network architecture 100 can be implemented at a logical level, a hardware level (e.g., physical), and/or both. For example, configurations can be implemented at a logical and/or hardware level based on connection attributes, endpoint or resource attributes, etc., such as endpoint types and/or application groups or profiles. In some examples, configurations can be implemented through a software-defined network (SDN), an underlay framework, and/or an overlay framework. Such configurations can define rules, policies, priorities, protocols, attributes, objects, profiles, groups, traffic, security parameters, etc., for routing, processing, and/or classifying traffic in the network architecture 100. For example, configurations can define attributes and objects for classifying and processing traffic based on endpoint groups (EPGs), security groups (SGs), VM types, BDs, VRFs, tenants, priorities, firewall rules, labels, addresses, etc.

### IPv6 and SRv6

Various aspects of the disclosure can include and/or implement IPv6 and/or segment routing systems, techniques, and environments. In general, in an IPV6 environment, various nodes in the network can be reached via an IPV6 address or prefix. Traffic can include IPv6 packets, which can include an IPV6 header that identifies a source and destination for the packets, and may include functions to be applied by one or more nodes/segments identified in the IPV6 header. In some cases, data stored in nodes can also be assigned an IPv6 address or prefix, which can be used to identify and access that data. For example, one or more nodes storing data can be assigned an IPv6 prefix, and each instance of the data can be assigned an IPV6 address within the IPV6 prefix. The IPV6 address of the data can be used to access the data. This scheme can ensure that requests for data addressed to an IPV6 address of the data are routed to the appropriate node(s) containing the data and associated with the IPV6 prefix.

Routing the IPV6 addresses corresponding to the nodes/applications in the network can be achieved in several ways. In some examples, network devices in the network can run Interior Gateway Protocol (IGP) to propagate routes to the IPV6 addresses. Other examples may use a mobility protocol, such as Identifier-Locator Addressing for IPV6, where edge routers perform translations between physical and virtual addresses. In some cases, network devices can use Border Gateway Protocol (BGP) to exchange routing information.

In many cases, segment routing (SR) can be used to establish and/or manage connectivity between networks, devices, and/or segments. SR is a routing paradigm, initially designed and/or used for traffic engineering, which allows a packet to follow a predefined path in an SR domain. The predefined path can be defined by a list of segments or SR list. In some aspects, IPv6 and SR techniques can be leveraged for accurate and efficient routing and/or networking operations.

In some examples, SR and IPv6 can be leveraged together by implementing an IPV6 header and an SRH in a packet. For example, in some cases, an SRH or an IPV6 extension header can be implemented to identify a list of segments for SR and a SegmentsLeft counter indicating the number of remaining segments to be processed until the final destination of the packet is reached. In some cases, the IPV6 destination address in an SRv6 packet can be overwritten with the address of the next segment in the SR list. The packet can traverse SR-capable routers until reaching the next intended SR hop or segment. Upon receipt of an SRv6 packet, an SR-capable router can set the destination address to the address of the next segment, and decrease the Segments Left counter. When the packet reaches the last SR hop/segment, the final destination of the packet can be copied to the IPv6 destination address field. Depending on the value of a flag in the header, the SRv6 header can be stripped by the last SR hop/segment so the destination receives a vanilla IPv6 packet.

The approaches herein can utilize segment routing (SR) to steer connection or communication requests between two network nodes such as servers or nodes on different clouds or cloud regions. IPv6 and SR, which are further described below, can be used to steer requests efficiently while limiting state information. The request will be routed to the nodes identified in the SR packet based on the IPV6 and SRv6 headers. The IPV6 header can include a Source Address (SA) and a Destination Address (DA), such as a destination server or node. An SR Header (SRH) can include a SID-list of SR nodes (e.g., S1, S2, S3, etc.) and a Segment Left (SL) counter which identifies the number of remaining destination servers or nodes.

### IPv6 Environment

In an IPV6 environment, such as an IPV6-centric data center, network nodes (e.g., servers, destinations, etc.) can be reached via an IPV6 physical prefix. For example, servers can run application services in isolated environments, such as virtual machines (VMs) or software containers, which can be assigned an IPv6 virtual address (VIP). In some cases, a virtual switch (e.g., Open vSwitch, vector packet processing, etc.) can be deployed on a server to route packets between physical and virtual interfaces on the server. This allows the network (e.g., data center) to be fully Layer-3 routed, without having to deploy Layer-2 tunnels such as VLANs or VXLANs.

Routing the VIPs corresponding to the different applications running in the data center can be achieved in several manners. In some examples, the virtual switches can run Interior Gateway Protocol (IGP) to propagate direct routes to the VIPs. Other examples may use a mobility protocol, such as Identifier-Locator Addressing for IPV6, wherein edge routers perform the translation between physical and virtual addresses. Moreover, network devices can use Border Gateway Protocol (BGP) to exchange routing information. As will be further explained below, the approaches herein implement segment routing to establish and manage the connectivity between clouds.

### Segment Routing (SR)

SR is a source-routing paradigm, initially designed for traffic engineering, which allows for a packet to follow a predefined path, defined by a list of segments (a SID list), inside an SR domain. The approaches herein leverage an SRv6 architecture and IPv6 connectivity to efficiently create and manage multi-cloud connectivity.

SRv6 and IPV6 can be leveraged together by implementing an IPV6 and SRv6 header in an IPv6 packet. For example, in some cases, an IPV6 extension header can be implemented to identify a list of segments for SR and a counter Segments Left, indicating the number of remaining segments to be processed until the final destination of the packet is reached. In an SRv6 packet, the IPV6 destination address can be overwritten with the address of the next segment. This way, the packet can go through SR-capable routers until reaching the next intended SR hop. Upon receipt of an SRv6 packet, an SR-capable router will set the destination address to the address of the next segment, and decrease the Segments Left counter. When the packet reaches the last SR hop, the final destination of the packet is copied to the IPV6 destination address field. Depending on the value of a flag in the header, the SRv6 header can be stripped by the last SR hop so that the destination receives a vanilla IPv6 packet.

### SDWAN Overlay Network

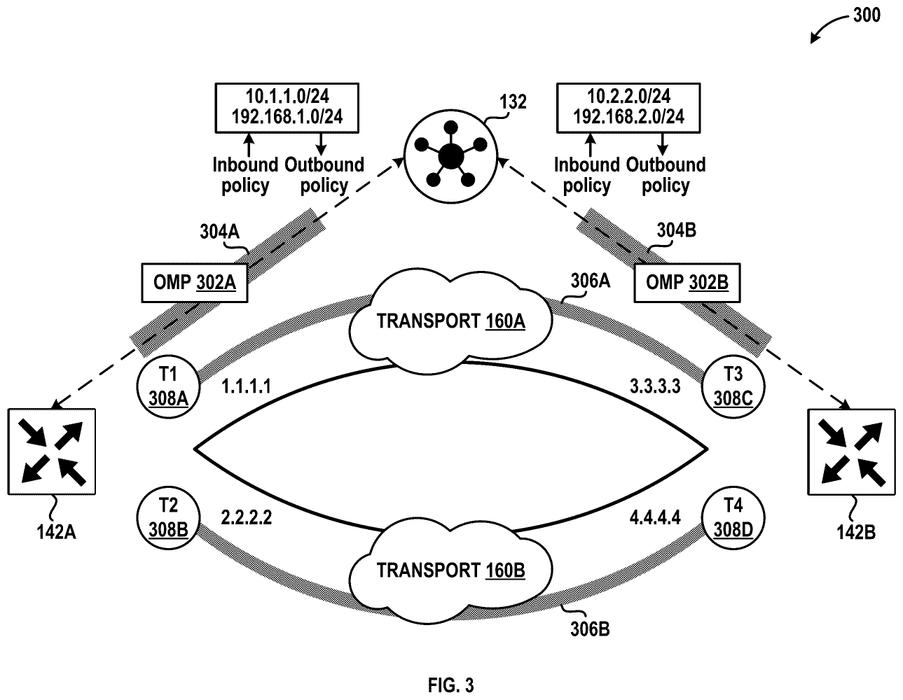

FIG. 3 illustrates an example of a diagram 300 showing the operation of OMP, which may be used in some embodiments to manage an overlay of a network (e.g., the network architecture 100). In this example, OMP messages 302A and 302B (collectively, 302) may be transmitted back and forth between the network controller appliance 132 and the edge network devices 142A and 142B, respectively, where control plane information, such as route prefixes, next-hop routes, crypto keys, policy information, and so forth, can be exchanged over respective secure DTLS or TLS connections (tunnels) such as connection 304A and connection 304B. The network controller appliance 132 can operate similarly to a route reflector. For example, the network controller appliance 132 can receive routes from the edge network devices 142, process and apply any policies to them, and advertise routes to other one(s) of the edge network devices 142 in the overlay. If there is no policy defined, the edge network devices 142 may behave in a manner similar to a full mesh topology, where each edge network devices 142 can connect directly to another edge network devices 142 at another site and receive full routing information from each site.

OMP can advertise three types of routes:

OMP routes, which can correspond to prefixes that are learned from the local site, or service side, of the edge network devices 142. The prefixes can be originated as static or connected routes, or from within, for example, the OSPF or BGP protocols, and redistributed into OMP so they can be carried across the overlay. OMP routes can advertise attributes such as transport location (TLOC) information (which can similar to a BGP next-hop IP address) and other attributes such as origin, originator, preference, site identifier, tag, and virtual private network (VPN). An OMP route may be installed in the forwarding table if the TLOC to which it points is active.

TLOC routes, which can correspond to logical tunnel termination points on the edge network devices 142 that connect into the transport network 160. In some embodiments, a TLOC route can be uniquely identified and represented by a three-tuple, including an IP address, link color, and encapsulation (e.g., Generic Routing Encapsulation (GRE), IPSec, etc.). In addition to system IP address, color, and encapsulation, TLOC routes can also carry attributes such as TLOC private and public IP addresses, carrier, preference, site identifier, tag, and weight. In some embodiments, a TLOC may be in an active state on a particular edge network device of the edge network devices 142 when an active BFD session is associated with that TLOC.

Service routes, which can represent services (e.g., firewall, distributed denial of service (DDoS) mitigator, load balancer, intrusion prevent system (IPS), intrusion detection systems (IDS), WAN optimizer, etc.) that may be connected to the local sites of the edge network devices 142 and accessible to other sites for use with service insertion. In addition, these routes can also include VPNs; the VPN labels can be sent in an update type to tell the network controller appliance 132 what VPNs are serviced at a remote site.

In the example of FIG. 3, OMP is shown running over the DTLS/TLS tunnels such as the connection 304A and the connection 304B established between the edge network devices 142 and the network controller appliance 132. In addition, the diagram 300 shows an IPSec tunnel 306A established between TLOC 308A and 308C over the WAN network (e.g., Internet transport network 160A) and an IPSec tunnel 306B established between TLOC 308B and TLOC 308D over the WAN transport network (e.g., Internet transport network 160B). Once the IPSec tunnels 306A and 306B are established, BFD can be enabled across each of them.

### SDWAN VPN Overlay

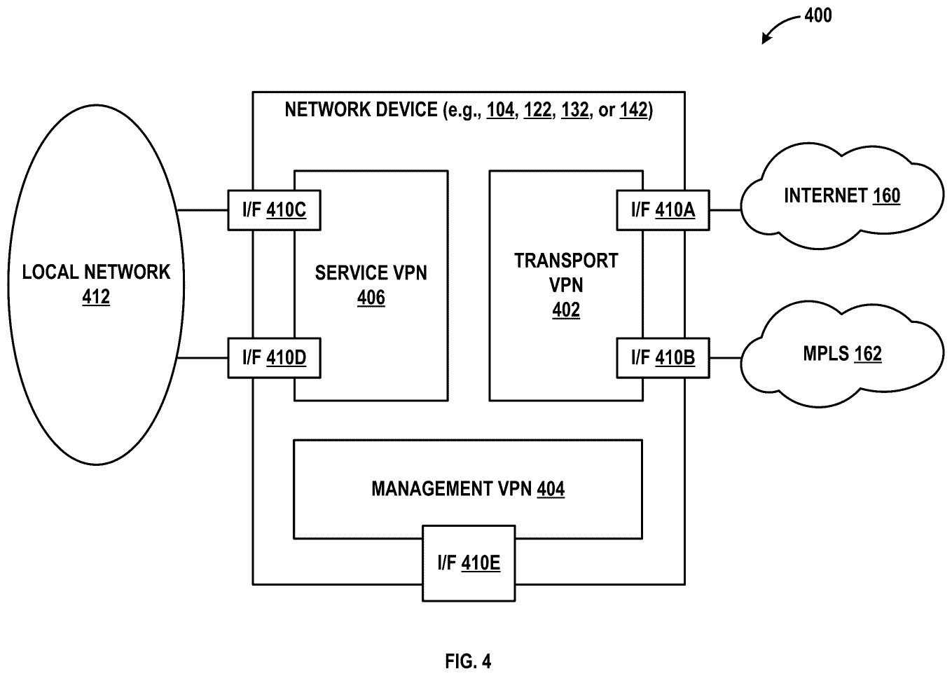

FIG. 4 illustrates an example of a diagram 400 showing the operation of VPNs, which may be used in some embodiments to provide segmentation for a network (e.g., the network architecture 100). VPNs can be isolated from one another and can have their own forwarding tables. An interface or sub-interface can be explicitly configured under a single VPN and may not be part of more than one VPN. Labels may be used in OMP route attributes and in the packet encapsulation, which can identify the VPN to which a packet belongs. The VPN number can be a four-byte integer with a value from 0 to 65530. In some embodiments, the network orchestrator appliance(s) 104, the network management appliance(s) 122, the network controller appliance(s) 132, and/or the edge network devices 142 can each include a transport VPN 402 and a management VPN 404. The transport VPN 402 can include one or more physical or virtual network interfaces (e.g., network interfaces 410A and 410B) that respectively connect to WAN transport networks (e.g., the MPLS network 162 and the transport network 160). Secure DTLS/TLS connections to the network controller appliance(s) 132 or between the network controller appliance(s) 132 and the network orchestrator appliance(s) 104 can be initiated from the transport VPN 402. In addition, static or default routes or a dynamic routing protocol can be configured inside the transport VPN 402 to get appropriate next-hop information so that the control plane 130 may be established and IPSec tunnels (not shown) can connect to remote sites.

The management VPN 404 can carry out-of-band management traffic to and from the network orchestrator appliance(s) 104, network management appliance(s) 122, network controller appliance(s) 132, and/or edge network devices 142 over a network interface 410C. In some embodiments, the management VPN 404 may not be carried across the overlay network.

In addition to the transport VPN 402 and the management VPN 404, the network orchestrator appliance(s) 104, network management appliance(s) 122, network controller appliance(s) 132, or edge network devices 142 can also include one or more service-side VPNs 406. Each of the one or more service-side VPNs 406 can include one or more physical or virtual network interfaces (e.g., network interfaces 410D and 410E) that connect to one or more local-site networks 412 and carry user data traffic. The one or more service-side VPNs 406 can be enabled for features such as OSPF or BGP, Virtual Router Redundancy Protocol (VRRP), QOS, traffic shaping, policing, and so forth. In some embodiments, user traffic can be directed over IPSec tunnels to other sites by redistributing OMP routes received from the network controller appliance(s) 132 at the one or more local-site networks 412 into the service-side VPN routing protocol. In turn, routes from the one or more local-site networks 412 can be advertised to other sites by advertising the service VPN routes into the OMP routing protocol, which can be sent to the network controller appliance(s) 132 and redistributed to other one(s) of the edge network devices 142 in the network. Although the network interfaces 410A-410E (collectively, 410) are shown to be physical interfaces in this example, one of ordinary skill in the art will appreciate that the interfaces 410A-410E in the transport and service VPNs can also be sub-interfaces instead.

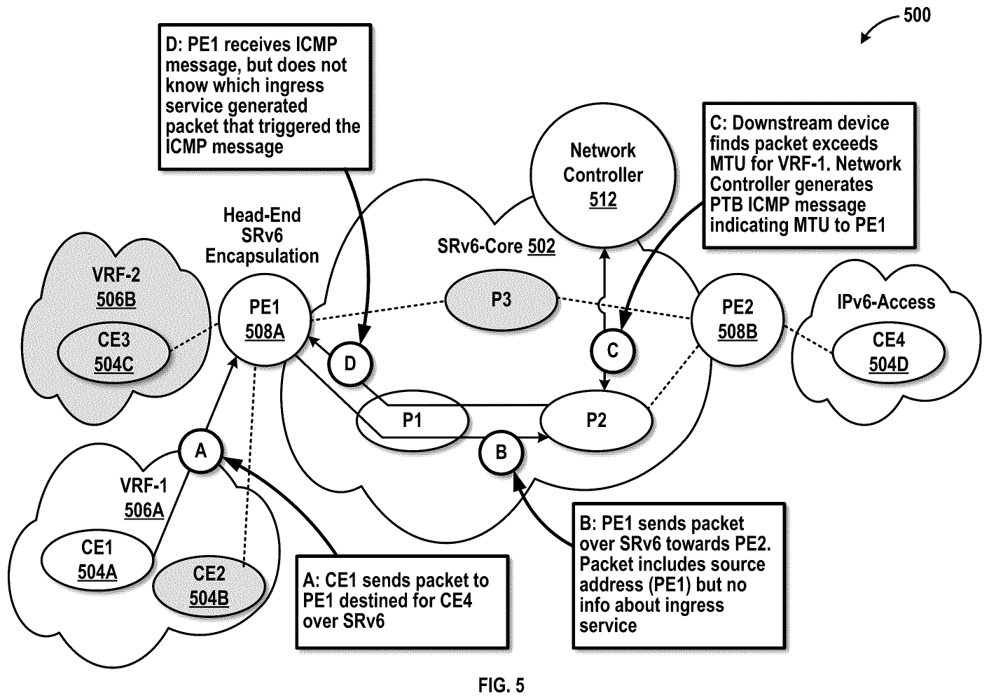

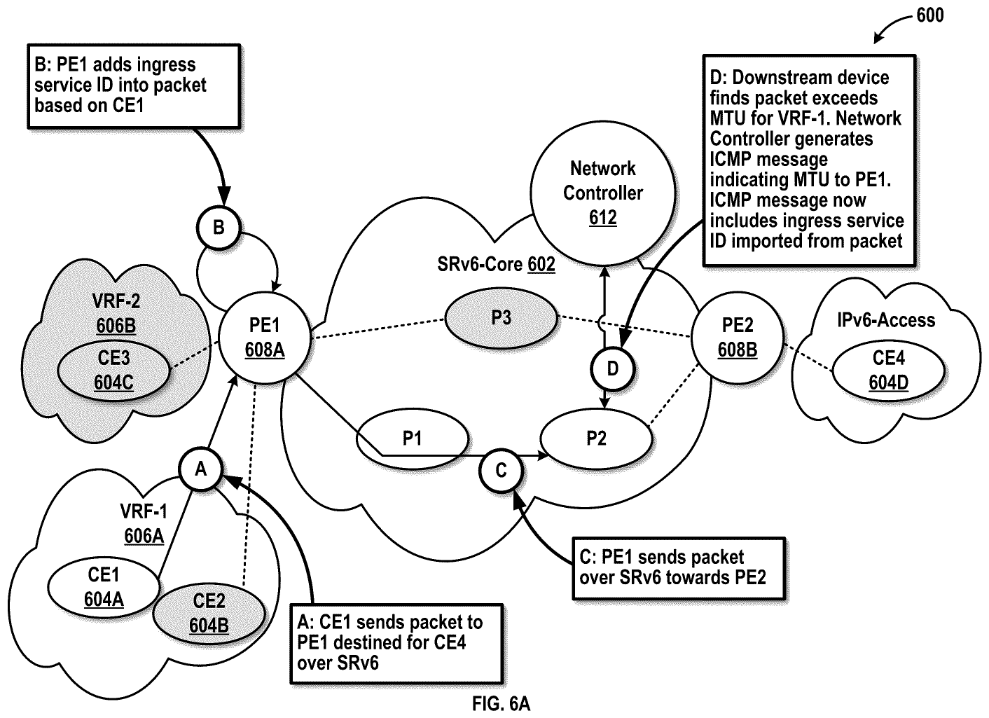

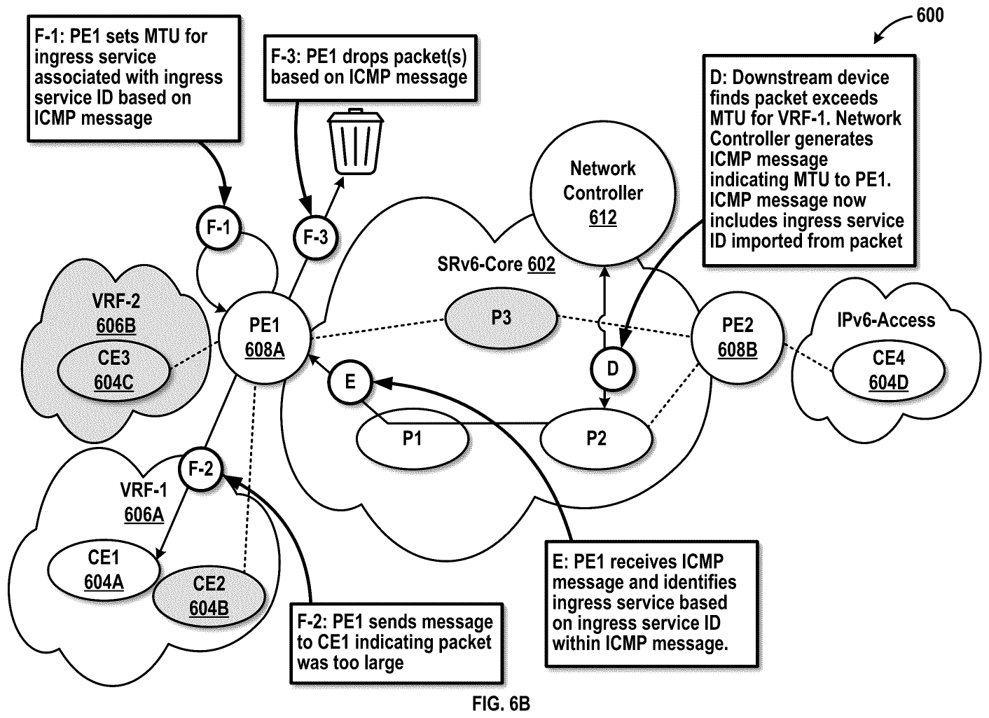

The present disclosure now turns to FIGS. 5-8B which outline the problem to be solved and the solutions presented herein. In particular, FIG. 5 shows the problem to be solved, and FIGS. 6A-8B show aspects of the solutions directed to the problem outlined with respect to FIG. 5.

### Problem and Illustration

FIG. 5 shows an example network topology 500 that shows the problem to be solved. In the example network topology 500, consider an SRv6 Core network 502 that facilitates communication between Customer Edge devices 504A-504D. Corresponding with the concepts discussed above with reference to FIGS. 1-4, the Customer Edge devices 504A-504D may be analogous to the one or more site network devices 208 and/or the one or more endpoints 206 of FIG. 2. These Customer Edge devices 504A-504D may be associated with a Virtual Routing and Forwarding (VRF) space, e.g., first VRF 506A and second VRF 506B in FIG. 5, which may be “behind” a first provider edge device 508A or second provider edge device 508B (analogous to edge network devices 142 of FIG. 1). A VRF and its Customer Edge device may be unknown to other components of the network outside of their associated one or more of the edge network devices 142.

In the example of FIG. 5, consider a first VRF 506A (“VRF-1”) associated with a first customer edge device 504A (“CE1”) and a second customer edge device 504B (“CE2”), and a second VRF 506B (“VRF-2”) associated with a third customer edge device 504C (“CE3”). Both the first VRF 506A and the second VRF 506B are “behind” a first provider edge device 508A (“PE1”), which communicates with the SRv6 Core network 502. Likewise, consider a fourth customer edge device 504D (“CE4”) which can be connected to the SRv6 Core network 502 through a second provider edge device 508B (“PE2”).

The SRv6 Core network 502 can facilitate communication between the first provider edge device 508A with the second provider edge device 508B. The SRv6 Core network 502 can include a plurality of nodes (e.g., a first intermediate node (“P1”), a second intermediate node (“P2”), and a third intermediate node (“P3”)), where sending a packet between adjacent nodes is considered a “hop”. The SRv6 Core network may also be managed by a network controller 512, which implements ICMP functionalities including generating and sending ICMP error messages.

Note that in real-world applications, a pathway through an SRv6 core network can include many “hops”, which can cause problems in conventional means of identifying a source VRF for a packet behind a customer edge device, particularly if a packet exceeds a Maximum Transmission Unit (MTU) value (also known as a “Packet Too Big” (PTB) error). Because of how SRv6 encapsulation adds encapsulated data to a packet at various nodes that the packet encounters, the packet sent from a source node (e.g., the first provider edge device 508A, in this example) may encounter a large quantity of hops before some downstream node identifies that the packet now exceeds an MTU value. ICMP error messages are sent on behalf of an intermediate or destination node back to a source node if there is a problem with the packet sent from the source node. When a packet exceeds MTU, a downstream device (e.g., network controller 512 or another device in communication with the first provider edge device 508A) implementing ICMP will generate a PTB ICMP error message to be sent back to the source of the offending packet. This action involves copying a source address of the offending packet (usually the provider edge device that is acting as a source node) into a destination address of the ICMP error message. These messages will include information about the type of error encountered, and will also include portions of the “offending” packet including IPv6 encapsulated headers belonging to the packet. However, current methods do not require encoding information about the ingress service (e.g., a VRF, a segment such as a micro-segment, a policy, a customer edge device, or a combination thereof behind the provider edge device) within packets. For SRv6 micro-segments (uSIDs), identifying the ingress service from contents of an ICMP error type “packet too big” can be impossible since only the egress PE service is identified in the IPV6 destination address (which is retained within ICMP errors).

Consider the example in FIG. 5. At circle (A) of FIG. 5, the first customer edge device 504A sends a packet to the first provider edge device 508A, where the packet is destined for the fourth customer edge device 504D which is connected over the SRv6 Core network 502. The packet may be a path MTU probe packet (e.g., intended to discover an MTU value for a local ingress service). At circle (B) of FIG. 5, the first provider edge device 508A sends the packet over the SRv6 Core network 502 towards the first provider edge device 508A. Note that the packet will include a source address (identifying the first provider edge device 508A) but is not necessarily required to provide information about the ingress service (e.g., the first VRF 506A). The packet may include a flow identifier, however this flow identifier is used for different purposes, e.g., to hash traffic between the ECMP paths. The flow identifier itself is not sufficient to identify the service from where the packet originated. The packet may also pick up SRv6 encapsulations along the pathway towards its destination, which increases the size of the packet.

At circle (C) of FIG. 5, a downstream device within the SRv6 Core network 502 finds that the packet exceeds MTU. The downstream device (e.g., network controller 512 or another device in communication with the first provider edge device 508A) generates a PTB ICMP error message that indicates the MTU and identifies the address of the first provider edge device 508A to be the destination address of the PTB ICMP error message. The PTB ICMP error message will also include a first portion of the offending packet, usually as much of the offending packet that will fit. The PTB ICMP error message is sent back to the first provider edge device 508A. At circle (D) of FIG. 5, the first provider edge device 508A receives the PTB ICMP error message, but because the originating packet had limited information about the ingress service that would be available within the resultant PTB ICMP error message, the first provider edge device 508A may not be able to know which ingress service generated the offending packet.

While some current methods help identify a destination SID and possibly an endpoint service associated with the SID (i.e., an egress PE service like 13vpn), these methods do not identify the source service (i.e., a VRF at the SR Source). Identifying the source VRF is not defined in drafts nor RFCs for SRv6. This is important when considering path MTU discovery, where a new ICMP error must be generated for the inner packet to be sent to its source address. Without a method to identify the local VRF or service associated with the inner packet PMTU discovery cannot work. Further, GRE or other tunnel endpoints can perform path MTU discovery like that described in RFC 1981 and RFC 4821, however but the scale of ‘tunnels’ for SRv6 is much greater and the ability to probe for PMTUD is hampered by that scale.

Other current solutions include IPv6 Source Address Programming, which is a mechanism to leverage 32 least significant bits (LSBs) of the IPV6 Source Address field to encode per-flow marking bits (e.g., slice identifier, path identifier, counting bits, extended entropy). However, using a source address in this way has had some issues especially with security, and may not be generally accepted nor used in the field.

As such, there are significant challenges in adopting an SRv6 solution for the case of dynamically varying path MTUs in an SRv6 core. While PMTUD and PTB error messages are one example, the problem is applicable to other types of ICMP error messages as well.

### Solution and Illustration

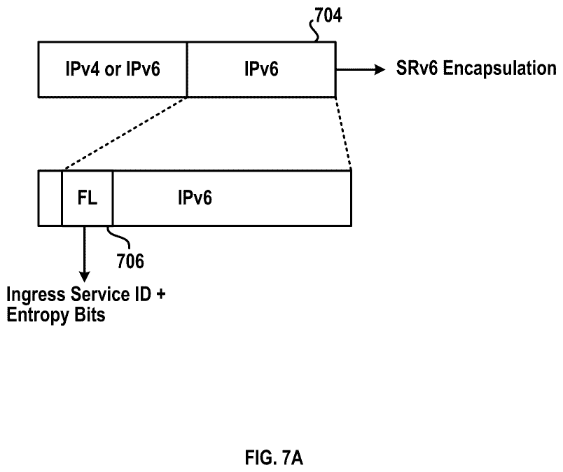

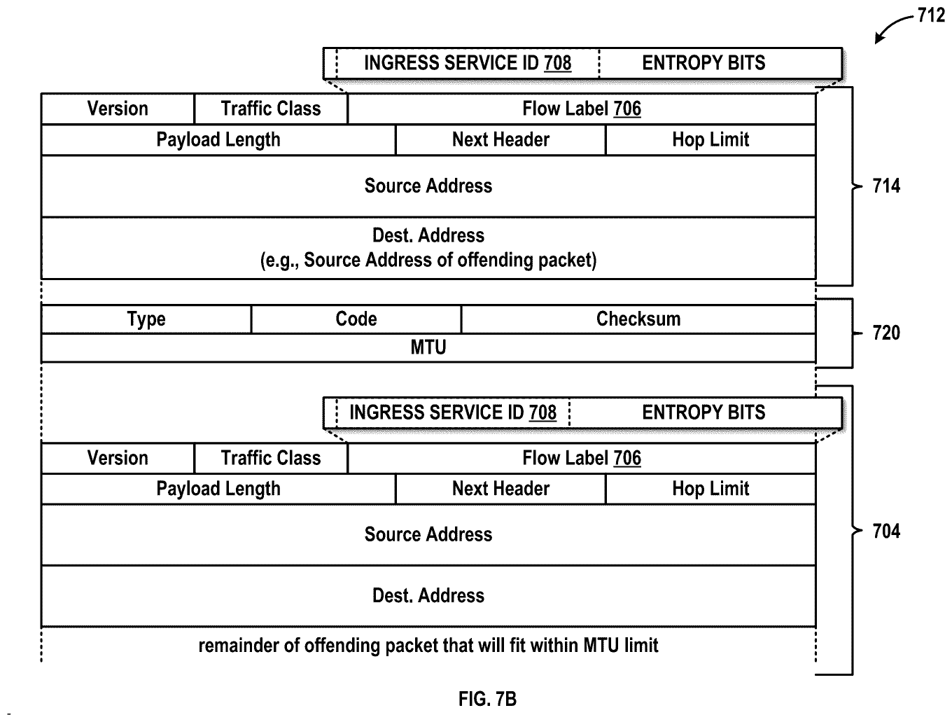

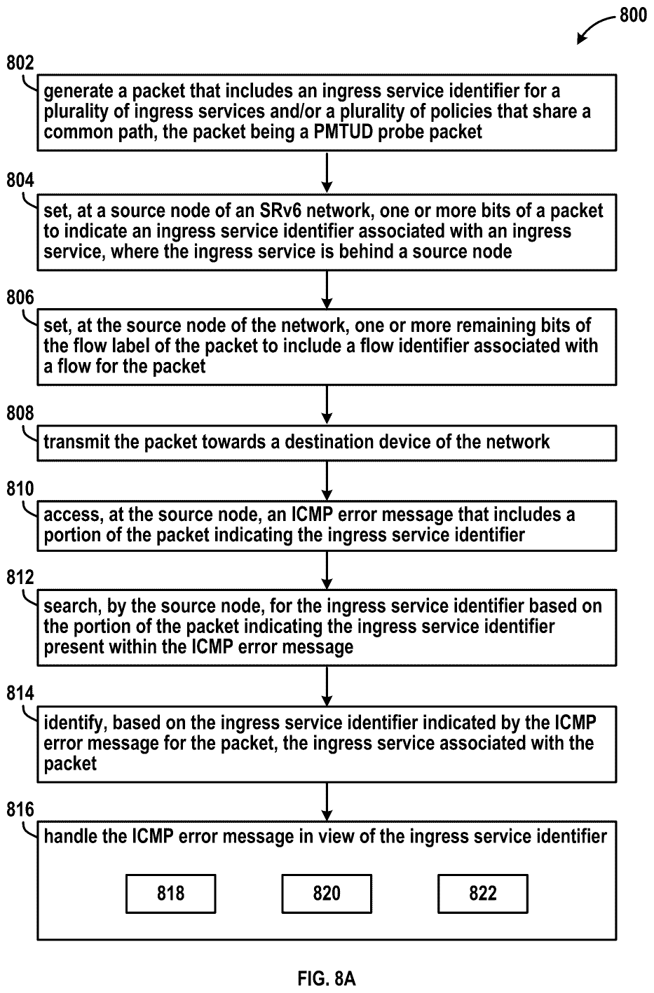

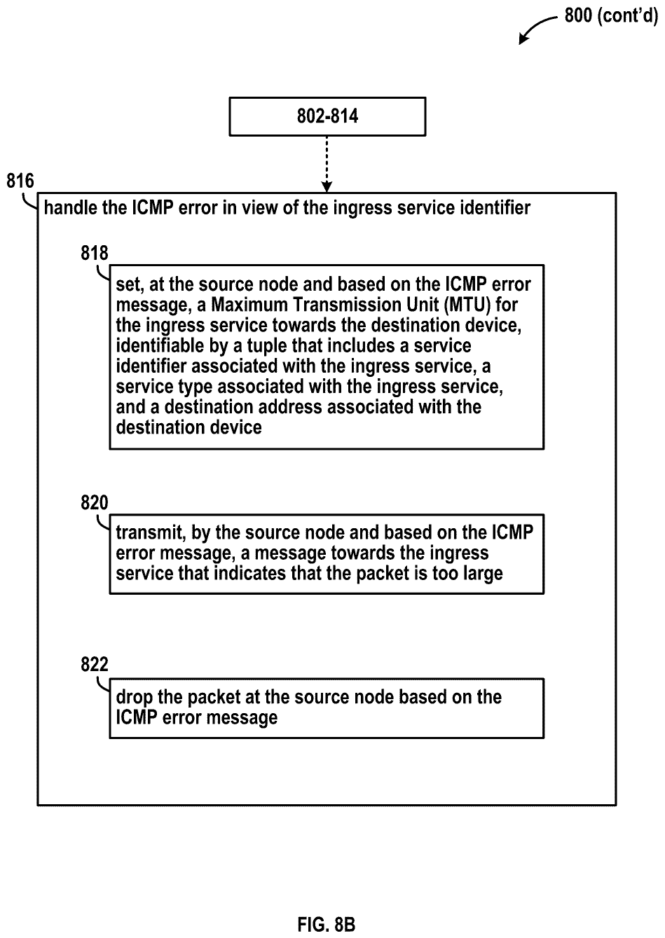

FIGS. 6A-7B illustrate a solution to the problems outlined above with respect to FIG. 5, and FIGS. 8A and 8B outline a process associated with the solutions illustrated in FIGS. 6A-7B. In particular, systems and methods outlined in this section improve ICMP error message handling in IPv6 networks as well as Path Maximum Transmission Unit (MTU) Discovery by ensuring that packets include ingress service identifiers. In particular, the systems and methods outlined herein aim to improve error message handling and MTU discovery in SRv6 core networks when a source node forwards a packet from an ingress service (e.g., a VPN or VRF behind a “head-end” source node) by carrying information about the ingress service within the packet in such a way that this information is retained within ICMP error messages, particularly those pertaining to ICMP “packet too big” (PTB) error messages.

FIGS. 6A and 6B show an example network topology 600 to illustrate a solution to the problem outlined in FIG. 5. Similar to FIG. 5, in the example network topology 600, an SRv6 Core network 602 facilitates communication between Customer Edge devices 604A-604D. Corresponding with the concepts discussed above with reference to FIGS. 1-4, the Customer Edge devices 604A-604D may be analogous to the one or more site network devices 208 and/or the one or more endpoints 206 of FIG. 2. These Customer Edge devices 604A-604D may be associated with a Virtual Routing and Forwarding (VRF) space, e.g., first VRFs 606A and second VRF 606B in FIGS. 6A and 6B, which may be “behind” a first provider edge device 608A (analogous to edge network devices 142 of FIG. 1). A VRF and its Customer Edge device may be unknown to other components of the network outside of their associated one or more of the edge network devices 142.

In the example of FIGS. 6A and 6B, consider a first VRF 606A (“VRF-1”) associated with a first customer edge device 604A (“CE1”) and a second customer edge device 604B (“CE2”), and a second VRF 606B (“VRF-2”) associated with a third customer edge device 604C (“CE3”). Both the first VRF 606A and the second VRF 606B are “behind” a first provider edge device 608A (“PE1”), which communicates with the SRv6 Core network 602. Likewise, consider a fourth customer edge device 604D (“CE4”) which can be connected to the SRv6 Core network 602 through a second provider edge device 608B (“PE2”).

The SRv6 Core network 602 can facilitate communication between the first provider edge device 608A with the second provider edge device 608B. The SRv6 Core network 602 can include a plurality of nodes (e.g., a first intermediate node (“P1”), a second intermediate node (“P2”), a third intermediate node (“P3”), etc.), where sending a packet between adjacent nodes is considered a “hop”. The SRv6 Core network may also be managed by a network controller 612, which implements ICMP functionalities including generating and sending ICMP error messages.

When a packet exceeds MTU, a downstream device (e.g., a network controller 612 or another device in communication with the first provider edge device 608A) implementing ICMP will generate a PTB ICMP error message to be sent back to the source of the offending packet. This action involves copying a source address of the offending packet (usually the provider edge device that is acting as a source node) into a destination address of the ICMP error message. Consistent with the previous discussion regarding FIG. 5, these messages will include information about the type of error encountered, and will also include portions of the “offending” packet including IPv6 encapsulated headers belonging to the packet. In contrast with the previous discussion regarding FIG. 5, information about the ingress service (e.g., a VRF or customer edge device behind the provider edge device) is encoded within the offending packet as an ingress service identifier, and as a result this information is also encoded in the ICMP error message. In particular, the ingress service identifier can be encoded within a flow label of the offending packet (and as a result, the ICMP error message) which, upon receipt of the ICMP error message at the source PE, can be used by the source PE to identify the ingress service associated with the offending packet.

Under the solution outlined herein, identifying the ingress service for SRv6 micro-segments (uSIDs) from contents of an ICMP error type “packet too big” is possible. Although only the egress PE service (e.g., source PE device) is identified in the IPV6 destination address of the ICMP error message, the source PE device can identify the ingress service based on the ingress service identifier that is retained from the offending packet within some portion of the ICMP error message.

The ingress service identifier can be placed within a flow label of the packet, as shown in FIGS. 7A and 7B. In such a case, the source node can then set the remaining bits in the flow label to uniquely identify the flow as in RFC 6437. Alternatively, or in addition to the flow label, the ingress service identifier can be part of a Segment Routing Header (SRH) Type Length Value (TLV) of the packet, a source address, or a destination address of the packet. However, note that placing the ingress service identifier within a source address or destination address of the packet may not be preferred in some contexts as such an action may raise security concerns.

Consider the example in FIGS. 6A and 6B. At circle (A) of FIG. 6A, the first customer edge device 604A sends a packet to the first provider edge device 608A, where the packet is destined for the fourth customer edge device 604D which is connected over the SRv6 Core network 602. The packet can be a regular packet with customer data, or can alternatively be a Path Maximum Transmission Unit Discovery (PMTUD) probe packet.

At circle (B) of FIG. 6A, the first provider edge device 608A (e.g., the source node) sets one or more bits of the packet to indicate an ingress service identifier associated with an ingress service. In some examples, the ingress service can include a VRF associated with a customer edge device behind the provider edge device. The one or more bits of the packet that indicate the ingress service identifier can be part of a flow label of the packet, and may be a VRF ID or a one-way hash of the VRF ID that can be reversed with a local table accessible by the first provider edge device 608A. Alternatively or in addition, the one or more bits that indicate the ingress service identifier can be part of a Segment Routing Header (SRH) Type Length Value (TLV) of the packet, a source address, and/or a destination address of the packet. In a further aspect, which will be discussed in greater detail herein, the ingress service identifier is associated with a plurality of ingress services and/or a plurality of policies that share a common path (e.g., where an ingress service identifier may be shared among different flows to eliminate redundancies). This is equally applicable to ingress services that may be non-compressed SIDs (e.g., those defined in RFC8986) and other SRv6 services.

At circle (C) of FIG. 6A, the first provider edge device 608A sends the packet over the SRv6 Core network 602 towards the second provider edge device 608B. Note that, unlike the example in FIG. 5, the packet will include a source address (identifying the first provider edge device 608A) and also includes information about the ingress service (e.g., the first VRF 606A). The packet may also pick up SRv6 encapsulations along the pathway towards its destination, which can increase the size of the packet.

At circle (D) of FIG. 6A, a downstream device within the SRv6 Core network 602 finds that the packet exceeds MTU. The downstream device (e.g., network controller 612 or another device in communication with the first provider edge device 608A) generates an ICMP error message that indicates the MTU and identifies the address of the first provider edge device 608A to be the destination address of the ICMP error message. The ICMP error message will also include the ingress service identifier, which was placed somewhere within an IPV6 header of the offending packet (e.g., as part of the flow label, TLV, or another grouping of bits) and as a result is imported into the ICMP error message. The ICMP error message will also include a first portion of the offending packet, usually as much of the offending packet that will fit. The ICMP error message is sent back to the first provider edge device 608A.

At circle (E) of FIG. 6B, the first provider edge device 608A receives the ICMP error message that includes a portion of the packet indicating the ingress service identifier. The first provider edge device 608A can then search for the ingress service identifier based on the portion of the packet indicating the ingress service identifier present within the ICMP error message, and can identify, based on the ingress service identifier indicated by the ICMP error message for the packet, the ingress service associated with the packet.

Upon receipt, the first provider edge device 608A has a few options for what to do with the ICMP error message, and may perform one or more of the following steps (e.g., outlined in circles (F-1), (F-2), and/or (F-3).

At circle (F-1), the first provider edge device 608A can set, based on the ICMP error message, an MTU for the ingress service towards the destination device, identifiable by a tuple that includes a service identifier associated with the ingress service, a service type associated with the ingress service, and a destination address associated with the destination device.

At circle (F-2), the first provider edge device 608A can transmit, based on the ICMP error message, a message towards the ingress service that indicates that the packet is too large (e.g., if the ICMP error message indicates a PTB error).

At circle (F-3), the first provider edge device 608A can drop the packet based on the ICMP error message.

### Packet Formatting

FIG. 7A shows a simplified example of SRv6 encapsulation with an IPV6 header 704 that encapsulates an IPV4 or IPv6 header. As shown, the encapsulated IPv4 or IPv6 header (e.g., the original header that the packet starts with) can include a flow label 706 (“FL”) which can include an ingress service identifier in addition to entropy bits which can uniquely identify the flow as in RFC 6437.

FIG. 7B shows an ICMP error message 712 that can be generated by a network controller or another component that implements ICMP protocol in response to an offending packet, which may be a Path MTU Discovery probe packet or another type of packet. RFC 4443 outlines a standard IPv6 ICMP error message format for PTB errors, however the example in FIG. 7B includes the ingress service identifier originally within the offending packet. The ICMP error message 712 includes a first IPv6 header 714 followed by an ICMP error message body 720 which denotes a type of error, and in the case of a PTB error, an MTU. Further, the ICMP error message 712 will include a portion of the offending packet, which will usually include IPv6 encapsulation headers (e.g., IPv6 header 704 and so forth) and may include part of a payload of the offending packet. The portion of the offending packet included within the ICMP error message 712 may include only as much as will fit within the MTU.

The first IPV6 header 714 sets a source address (e.g., a source address associated with the network controller or another component that implements ICMP protocol) and a destination address (e.g., a source address copied from the offending packet). Further, the first IPv6 header will include the flow label 706 copied from the offending packet (e.g., from the IPV6 header 704 of the offending packet). Importantly, the flow label 706 can include one or more bits that indicate an ingress service identifier 708 associated with an ingress service which is behind the source provider edge device (e.g., as a VRF ID or a one-way hash of the VRF ID that can be reversed with a local table).

The ICMP error message body 720 can include information about the ICMP error message and the type of error that is being reported. Further, the ICMP error message body can denote an MTU.

The second IPv6 header (e.g., the IPV6 header 704 of the offending packet) includes a source address (e.g., a source address associated with a first provider edge device or a previous hop of the offending packet) and a destination address (e.g., provider edge device associated with a destination device that the offending packet was sent towards or a next hop). Further, the second IPv6 header will include the flow label 706 of the offending packet, which originates from the source provider edge device. Importantly, the flow label 706 can include one or more bits that indicate the ingress service identifier 708 associated with the ingress service which is behind the source provider edge device (e.g., as a VRF ID or a one-way hash of the VRF ID that can be reversed with a local table).

Alternatively, or in addition to the flow label 706, the ingress service identifier 708 can be part of a Segment Routing Header (SRH) Type Length Value (TLV) of the packet, a source address, or a destination identifier of the packet.

### Common Path and VPN-SID Optimization

In some examples, the packet is a Path Maximum Transmission Unit Discovery (PMTUD) probe packet. To discover path-MTU in cases where multiple services share the same path and avoid redundancies, a single probe packet can be generated for services which share a common path to optimize the number of service-IDs and probes.

This arrangement can be used to consolidate PMTUD probing for multiple similar flows (where flow labels assigned to packets are different, but they share the same ingress service behind the first provider edge device).

### A. Common Path Optimization:

In SRv6, currently the ingress services could be a combination of VPN+Traffic-Engineering. On the head-end, there could be multiple combinations of VPN's and the SRv6-Policies could be present. Instead of probing all the combinations individually, the SRv6-Policy Manager and FIB could identify and consolidate the paths and uniquely generate a ingress service identifier for those matching paths and generate a single probe packet for the ingress service identifier. In other words, the ingress service identifier can be associated with a plurality of ingress services and/or a plurality of policies that share a common path. A source provider edge device can generate the PMTUD probe packet that includes the ingress service identifier for the plurality of ingress services and/or the plurality of policies that share a common path.

For example:

$$VPN 1 + \text{Policy-1} ( S 1 , S 2 , S 3 - ( \text{Node-} SID ) ) \text{==>} Service \text{-ID-1}$$

$$VPN 1 + \text{Policy-2} ( S 1 , S 2 , S 3 - ( \text{Node-} SID ) ) \text{==>} Service \text{-ID-1}$$

$$\text{Policy-1} ( S 1 , S 2 , S 3 - ( \text{Node-} SID ) ) \text{==>} Service \text{-ID-1}$$

$$\text{Policy-2} ( S 1 , S 2 , S 3 - ( \text{Node-} SID ) ) \text{==>} Service \text{-ID-1}$$

In the above example, only one PMTUD probe is required for compatible pathways instead of four PMTUD probes.

Further, note that the ingress service identifier may be placed anywhere within the probe packet to identify the set of services associated with it (e.g., ICMP Echo identifier, TWAMP SID).

### B. VPN-SID Optimization:

In some examples, a VPN-SID and a policy can be combined to share an ingress service identifier, where the policy has the last SID as a Adj-SID in the SID-List then any VPN-SID combination need to run only the policy specific probing. In other words, the ingress service identifier can be associated with a plurality of ingress services and/or a plurality of policies that share a common path, and the plurality of policies can each include a segment identifier list having a last segment identifier, the last segment identifier being an adjacency segment identifier. A source provider edge device can generate the PMTUD probe packet that includes the ingress service identifier for the plurality of ingress services and/or the plurality of policies that share a common path.

For Example:

$$VPN 1 + \text{Policy-1} ( S 1 , S 2 , S 3 - ( Adj - SID ) ) \text{==>} Service \text{-ID-1}$$

$$VPN 2 + \text{Policy-2} ( S 1 , S 2 , S 3 - ( Adj - SID ) ) \text{==>} Service \text{-ID-1}$$

$$VPN 3 + \text{Policy-2} ( S 1 , S 2 , S 3 - ( \text{Adj-} SID ) ) \text{==>} Service \text{-ID-1}$$

In the above example, only one PMTUD probe is required for compatible pathways instead of three PMTUD probes.

Further, note that the ingress service identifier may be placed anywhere within the probe packet to identify the set of services associated with it (e.g., ICMP Echo identifier, TWAMP SID).

### Process

FIGS. 8A and 8B outline a process 800 for improving ICMP error message handling in IPv6 networks as well as Path Maximum Transmission Unit (MTU) Discovery by ensuring that packets include ingress service identifiers.

Referring to FIG. 8A, step 802 of process 800 includes generating a packet that includes an ingress service identifier for a plurality of ingress services and/or a plurality of policies that share a common path. The plurality of policies can, for example, each include a segment identifier list having a last segment identifier. In some examples, the last segment identifier can be an adjacency segment identifier. Step 802 is optional, and applies when the packet is a PMTUD probe packet for path MTU discovery. The following steps of process 800 are applicable for when the packet is a PMTUD probe packet and also for when the packet is part of a communication flow between devices of an SRv6 network.

Step 804 of process 800 includes setting, at a source node of an SRv6 network, one or more bits of the packet (which may or may not be a PMTUD probe packet) to indicate the ingress service identifier associated with the ingress service, where the ingress service is behind a source node. The one or more bits of the packet that indicate the ingress service identifier can be part of a flow label of the packet, and may be a VRF ID or a one-way hash of the VRF ID that can be reversed with a local table accessible by the source node. Alternatively, or in addition to the flow label, the ingress service identifier can be part of a Segment Routing Header (SRH) Type Length Value (TLV) of the packet, a source address, or a destination address of the packet. The source node may be a first provider edge device (e.g., first provider edge device 608A shown in FIG. 6A), and the ingress service can be a VRF, a segment such as a micro-segment (uSID), a policy, a customer edge device, or a combination thereof. Step 806 of process 800 can include setting, at the source node of the network, one or more remaining bits of the flow label of the packet to include a flow identifier associated with a flow for the packet. This may be accomplished in accordance with known standards such as those outlined in RFC 6437. Step 808 of process 800 can include transmitting, by the source node, the packet towards a destination device of the network.

Step 810 of process 800 can include accessing, at the source node and from a network device in communication with the source node, an ICMP error message that includes a portion of the packet indicating the ingress service identifier. The ICMP error message can be formatted as in the example of FIG. 7B, and includes the ingress service identifier due to the presence of the ingress service identifier in the packet that was originally transmitted in step 806 by the source node. Step 812 of process 800 can include searching, by the source node, for the ingress service identifier based on the portion of the packet indicating the ingress service identifier present within the ICMP error message. Step 814 of process 800 can include identifying, based on the ingress service identifier indicated by the ICMP error message for the packet, the ingress service associated with the packet. The source node may search within a local table to identify the ingress service that is associated with the packet based on the ingress service identifier. As discussed above with respect to step 802, the ingress service identifier may jointly apply to a plurality of ingress services and/or a plurality of policies behind the source node that share a common path.

Step 816 of process 800 can include handling the ICMP error message in view of the ingress service identifier, and may encompass one or more of step 818, step 820, or step 822 of process 800 elaborated on in FIG. 8B.

Referring to FIG. 8B, step 816 of process 800 can encompass one or more of step 818, step 820, or step 822 of process 800. Step 818 of process 800 includes setting, at the source node and based on the ICMP error message, a Maximum Transmission Unit (MTU) for the ingress service towards the destination device, identifiable by a tuple that includes a service identifier associated with the ingress service, a service type associated with the ingress service, and a destination address associated with the destination device. Step 820 of process 800 includes transmitting, by the source node and based on the ICMP error message, a message towards the ingress service that indicates that the packet is too large. Step 822 of process 800 includes dropping the packet at the source node based on the ICMP error message.

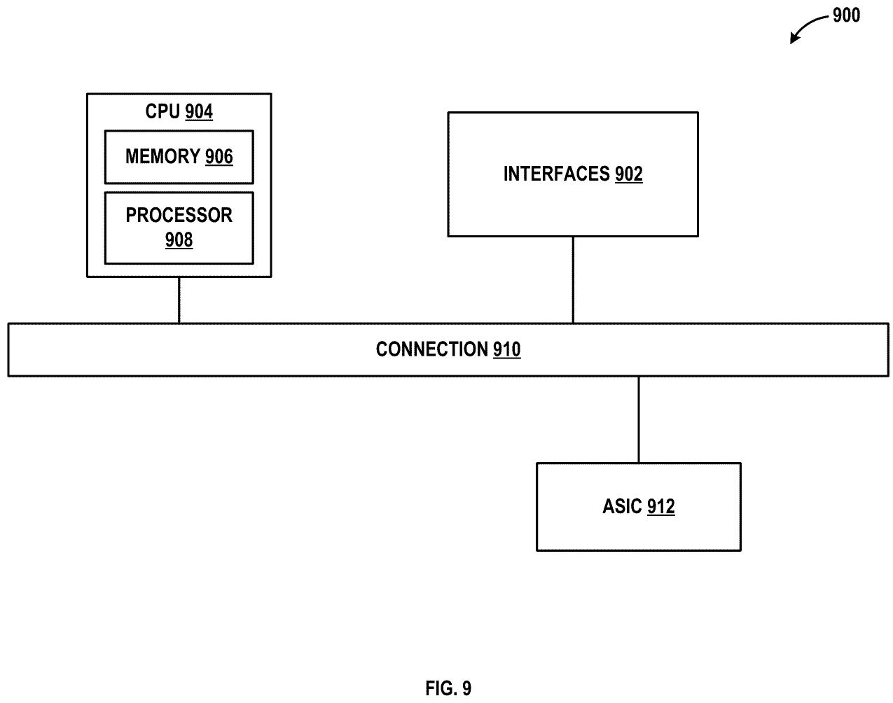

FIG. 9 illustrates an example network device 900 suitable for performing switching, routing, load balancing, and other networking operations. The example network device 900 can be implemented as switches, routers, nodes, metadata servers, load balancers, client devices, and so forth.

Network device 900 includes a central processing unit (CPU) such as CPU 904, interfaces 902, and a bus 910 (e.g., a PCI bus). When acting under the control of appropriate software or firmware, the CPU 904 is responsible for executing packet management, error detection, and/or routing functions. The CPU 904 preferably accomplishes all these functions under the control of software including an operating system and any appropriate applications software. CPU 904 may include one or more processors such as processor 908, such as a processor from the INTEL X86 family of microprocessors. In some cases, processor 908 can be specially designed hardware for controlling the operations of network device 900. In some cases, a memory 906 (e.g., non-volatile RAM, ROM, etc.) also forms part of CPU 904. However, there are many different ways in which memory could be coupled to the system.

The interfaces 902 are typically provided as modular interface cards (sometimes referred to as “line cards”). Generally, they control the sending and receiving of data packets over the network and sometimes support other peripherals used with the network device 900. Among the interfaces that may be provided are Ethernet interfaces, frame relay interfaces, cable interfaces, DSL interfaces, token ring interfaces, and the like. In addition, various very high-speed interfaces may be provided such as fast token ring interfaces, wireless interfaces, Ethernet interfaces, Gigabit Ethernet interfaces, ATM interfaces, HSSI interfaces, POS interfaces, FDDI interfaces, WIFI interfaces, 3G/4G/5G cellular interfaces, CAN BUS, LoRA, and the like. Generally, these interfaces may include ports appropriate for communication with the appropriate media. In some cases, they may also include an independent processor and, in some instances, volatile RAM. The independent processors may control such communications intensive tasks as packet switching, media control, signal processing, crypto processing, and management. By providing separate processors for the communication intensive tasks, these interfaces allow the master CPU (e.g., CPU 904) to efficiently perform routing computations, network diagnostics, security functions, etc.

Although the system shown in FIG. 9 is one specific network device of the present disclosure, it is by no means the only network device architecture on which the present disclosure can be implemented. For example, an architecture having a single processor that handles communications as well as routing computations, etc., is often used. Further, other types of interfaces and media could also be used with the network device 900.

Regardless of the network device's configuration, it may employ one or more memories or memory modules (including memory 906) configured to store program instructions for the general-purpose network operations and mechanisms for roaming, route optimization and routing functions described herein. The program instructions may control the operation of an operating system and/or one or more applications, for example. The memory or memories may also be configured to store tables such as mobility binding, registration, and association tables, etc. Memory 906 could also hold various software containers and virtualized execution environments and data.

The network device 900 can also include an application-specific integrated circuit (ASIC) such as ASIC 912, which can be configured to perform routing and/or switching operations. The ASIC 912 can communicate with other components in the network device 900 via the bus 910, to exchange data and signals and coordinate various types of operations by the network device 900, such as routing, switching, and/or data storage operations, for example.

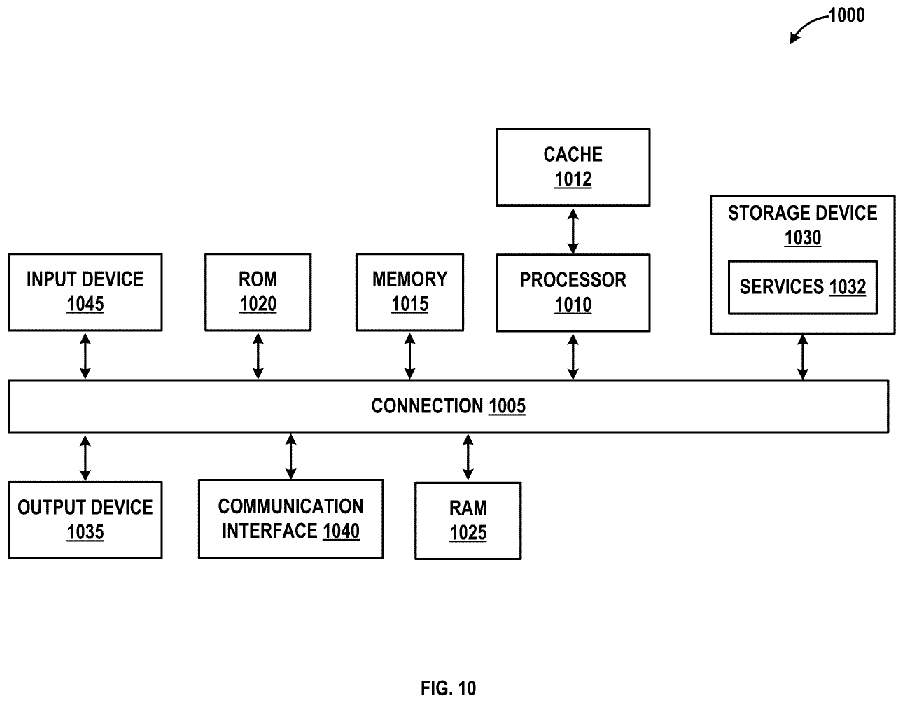

FIG. 10 shows an example of computing system 1000, which can be for example any computing device making up or in communication with first provider edge device 508A or any component thereof in which the components of the system are in communication with each other using connection 1005. Connection 1005 can be a physical connection via a bus, or a direct connection into processor 1010, such as in a chipset architecture. Connection 1005 can also be a virtual connection, networked connection, or logical connection.

In some embodiments computing system 1000 is a distributed system in which the functions described in this disclosure can be distributed within a datacenter, multiple datacenters, a peer network, etc. In some embodiments, one or more of the described system components represents many such components each performing some or all of the function for which the component is described. In some embodiments, the components can be physical or virtual devices.

Example computing system 1000 includes at least one processing unit (CPU or processor) such as processor 1010 and connection 1005 that couples various system components including system memory 1015, such as read only memory (e.g., ROM 1020) and random access memory (e.g., RAM 1025) to processor 1010. Computing system 1000 can include a cache of high-speed memory 1012 connected directly with, in close proximity to, or integrated as part of processor 1010.

Processor 1010 can include any general purpose processor and a hardware service or software service, such as services 1032 stored in storage device 1030, configured to control processor 1010 as well as a special-purpose processor where software instructions are incorporated into the actual processor design. Processor 1010 may essentially be a completely self-contained computing system, containing multiple cores or processors, a bus, memory controller, cache, etc. A multi-core processor may be symmetric or asymmetric.

To enable user interaction, computing system 1000 includes an input device 1045, which can represent any number of input mechanisms, such as a microphone for speech, a touch-sensitive screen for gesture or graphical input, keyboard, mouse, motion input, speech, etc. Computing system 1000 can also include output device 1035, which can be one or more of a number of output mechanisms known to those of skill in the art. In some instances, multimodal systems can enable a user to provide multiple types of input/output to communicate with computing system 1000. Computing system 1000 can include communications interface 1040, which can generally govern and manage the user input and system output. There is no restriction on operating on any particular hardware arrangement and therefore the basic features here may easily be substituted for improved hardware or firmware arrangements as they are developed.

Storage device 1030 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read only memory (ROM), and/or some combination of these devices.

The storage device 1030 can include software services, servers, services, etc., that when the code that defines such software is executed by the processor 1010, it causes the system to perform a function. In some embodiments, a hardware service that performs a particular function can include the software component stored in a computer-readable medium in connection with the necessary hardware components, such as processor 1010, connection 1005, output device 1035, etc., to carry out the function.

For clarity of explanation, in some instances the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program, or a collection of programs that carry out a specific function. In some embodiments, a service can be considered a server. The memory can be a non-transitory computer-readable medium.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, solid state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

What is claimed is:

1. A method, comprising:
setting, at a source node of an SRv6 network, one or more bits of a packet to indicate an ingress service identifier associated with an ingress service, where the ingress service is behind a source node;
transmitting, by the source node, the packet towards a destination device of the SRv6 network;
accessing, at the source node and from a network device in communication with the source node, an Internet Control Message Protocol error message that includes a portion of the packet indicating the ingress service identifier; and
identifying, based on the ingress service identifier indicated by the Internet Control Message Protocol error message for the packet, the ingress service associated with the packet.

2. The method of claim 1, further comprising:
setting, at the source node and based on the Internet Control Message Protocol error message, a Maximum Transmission Unit for the ingress service towards the destination device, identifiable by a tuple that includes a service identifier associated with the ingress service, a service type associated with the ingress service, and a destination address associated with the destination device.

3. The method of claim 1, further comprising:
transmitting, by the source node and based on the Internet Control Message Protocol error message, a message towards the ingress service that indicates that the packet is too large.

4. The method of claim 1, further comprising:
searching, by the source node, for the ingress service identifier based on the portion of the packet indicating the ingress service identifier present within the Internet Control Message Protocol error message.

5. The method of claim 1, the one or more bits of the packet indicating the ingress service identifier being part of a flow label of the packet.

6. The method of claim 5, further comprising:
setting, at the source node, one or more remaining bits of the flow label of the packet to include a flow identifier associated with a flow for the packet.

7. The method of claim 1, the one or more bits of the packet indicating the ingress service identifier being part of a Segment Routing Header (SRH) Type Length Value (TLV) of the packet.

8. The method of claim 1, the ingress service identifier being associated with a plurality of ingress services and/or a plurality of policies that share a common path.

9. The method of claim 8, the plurality of policies each including a segment identifier list having a last segment identifier, the last segment identifier being an adjacency segment identifier.

10. The method of claim 1, the packet being a Path Maximum Transmission Unit Discovery probe packet.

11. The method of claim 10, further comprising:
generating the Path Maximum Transmission Unit Discovery probe packet that includes the ingress service identifier for a plurality of ingress services and/or a plurality of policies that share a common path.

12. A system, comprising:
a processor in communication with a memory, the memory including instructions executable by the processor to:
set, at a source node of an SRv6 network, one or more bits of a packet to indicate an ingress service identifier associated with an ingress service, where the ingress service is behind a source node;
transmit, by the source node, the packet towards a destination device of the SRv6 network;
access, at the source node and from a network device in communication with the source node, an Internet Control Message Protocol error message that includes a portion of the packet indicating the ingress service identifier; and
identify, based on the ingress service identifier indicated by the Internet Control Message Protocol error message for the packet, the ingress service associated with the packet.

13. The system of claim 12, the memory further including instructions executable by the processor to:
set, at the source node and based on the Internet Control Message Protocol error message, a Maximum Transmission Unit MTU for the ingress service towards the destination device, identifiable by a tuple that includes a service identifier associated with the ingress service, a service type associated with the ingress service, and a destination address associated with the destination device.

14. The system of claim 12, the memory further including instructions executable by the processor to:
transmit, by the source node and based on the Internet Control Message Protocol error message, a message towards the ingress service that indicates that the packet is too large.

15. The system of claim 12, the memory further including instructions executable by the processor to:
search, by the source node, for the ingress service identifier based on the portion of the packet indicating the ingress service identifier present within the Internet Control Message Protocol error message.

16. The system of claim 12, the one or more bits of the packet indicating the ingress service identifier being part of a flow label of the packet.

17. The system of claim 16, further comprising:
setting, at the source node of the SRv6 network, one or more remaining bits of the flow label of the packet to include a flow identifier associated with a flow for the packet.

18. The system of claim 12, the ingress service identifier being associated with a plurality of ingress services and/or a plurality of policies that share a common path.

19. The system of claim 12, the packet being a Path Maximum Transmission Unit Discovery probe packet.

20. One or more non-transitory computer readable media comprising computer-readable instructions stored thereon which, when executed by one or more processors, cause the one or more processors to:
set, at a source node of an SRv6 network, one or more bits of a packet to indicate an ingress service identifier associated with an ingress service, where the ingress service is behind a source node;
transmit, by the source node, the packet towards a destination device of the SRv6 network;
access, at the source node and from a network device in communication with the source node, an Internet Control Message Protocol error message that includes a portion of the packet indicating the ingress service identifier; and
identify, based on the ingress service identifier indicated by the Internet Control Message Protocol error message for the packet, the ingress service associated with the packet.
